(19) United States
(12) Patent Application Publication
(10) Pub. No.: US 2019/0198873 A1
(43) Pub. Date: Jun. 27, 2019

(54) NEGATIVE ELECTRODE ACTIVE MATERIAL AND NEGATIVE ELECTRODE FOR SODIUM SECONDARY BATTERY USING MOLTEN SALT ELECTROLYTE, AND SODIUM SECONDARY BATTERY USING MOLTEN SALT ELECTROLYTE

(71) Applicant: SUMITOMO ELECTRIC INDUSTRIES, LTD., Osaka-shi, Osaka (JP)

(72) Inventors: Atsushi FUKUNAGA, Osaka-shi, Osaka (JP); Shinji INAZAWA, Osaka-shi, Osaka (JP); Koji NITTA, Osaka-shi, Osaka (JP); Shoichiro SAKAI, Osaka-shi, Osaka (JP); Koma NUMATA, Osaka-shi, Osaka (JP); Eiko ITANI, Osaka-shi, Osaka (JP)

(21) Appl. No.: 14/127,473

(22) PCT Filed: Apr. 18, 2013
(86) PCT No.: PCT/JP2013/061444

§ 371 Date: Dec. 18, 2013

(51) Int. Cl. H01M 4/52; H01M 10/39; H01M 4/485

(52) U.S. Cl. CPC H01M 4/523; H01M 4/485; H01M 10/399

(57) ABSTRACT

An object of the present invention is to provide a negative electrode active material etc. which have a high capacity density and which can improve cycle characteristics of a sodium secondary battery using a molten salt electrolyte. The negative electrode active material for a sodium secondary battery using a molten salt electrolyte includes tricobalt tetroxide. In the negative electrode active material, the tricobalt tetroxide preferably has an average particle size d₅₀ of 10 μm or less and a maximum particle size dₘₐₓ of 30 μm or less.

### TECHNICAL FIELD

The present invention relates to a negative electrode active material and a negative electrode for a sodium secondary battery using a molten salt electrolyte, and a sodium secondary battery using a molten salt electrolyte.

### BACKGROUND ART

In recent years, power generation using natural energy such as sunlight, wind power, or the like has been actively conducted. Such power generation using natural energy is influenced by many factors such as the climate and the weather, and adjustment of the amount of power generated in order to meet the demand for power cannot be performed. Thus, it is essential to level out the supply of power with respect to the load. For this leveling out, it is necessary to charge and discharge electrical energy. As means therefor, secondary batteries having a high energy density and a high efficiency may be used.

As one of such secondary batteries having a high energy density and a high efficiency, a sodium-sulfur (NAS) battery is known. For example, PTL 1 discloses an NAS battery including molten metallic sodium functioning as a negative electrode active material and molten sulfur functioning as a positive electrode active material, in which the two active materials are separated by a β-alumina solid electrolyte which selectively has conductivity with respect to sodium ions.

In addition, a non-aqueous electrolyte battery (PTL 2) in which a sodium salt is dissolved in an organic solvent, which is similar to a lithium secondary battery, and a battery including a molten salt functioning as an electrolyte (PTL 3), these batteries being different from the NAS battery, are also known as sodium secondary batteries. In these existing sodium secondary batteries using a non-aqueous electrolyte or a molten salt electrolyte, metallic Na, Sn, Zn, or the like is used as a negative electrode active material. However, there is a risk in using metallic Na in that, for example, it may combust when a problem occurs in the battery. Regarding Sn and Zn, when this metal is alloyed with Na in an electrolyte solution, the volume thereof significantly changes. Therefore, when the resulting battery is repeatedly used, the negative electrode active material may detach from the electrode, resulting in a problem of poor cycle characteristics.

### CITATION LIST

### Patent Literature

PTL 1: Japanese Unexamined Patent Application Publication No. 2007-273297
PTL 2: Japanese Unexamined Patent Application Publication No. 2010-102917
PTL 3: Japanese Unexamined Patent Application Publication No. 2011-192474

### SUMMARY OF INVENTION

### Technical Problem

In view of the above problems, an object of the present invention is to provide a negative electrode active material etc. which have a high capacity density and which can improve cycle characteristics of a sodium secondary battery using a molten salt electrolyte.

### Solution to Problem

As a result of intensive studies conducted in order to solve the above problems, the inventors of the present invention found that it is effective to use tricobalt tetroxide as a negative electrode active material of a sodium secondary battery using a molten salt electrolyte, and completed the present invention. The present invention includes the following configuration.

(1) A negative electrode active material for a sodium secondary battery using a molten salt electrolyte includes tricobalt tetroxide.

(2) In the negative electrode active material described in (1) above, the tricobalt tetroxide has an average particle size d₅₀ of 10 μm or less and a maximum particle size dₘₐₓ of 30 μm or less.

(3) A negative electrode for a sodium secondary battery using a molten salt electrolyte includes, as a negative electrode active material, the negative electrode active material described in (1) or (2) above.

(4) A sodium secondary battery using, as an electrolyte, a molten salt electrolyte containing a sodium ion includes a positive electrode, a negative electrode, and a separator disposed between the positive electrode and the negative electrode, in which the negative electrode is the negative electrode described in (3) above.

(5) In the sodium secondary battery using a molten salt electrolyte described in (4) above, the electrolyte contains NaFSA and KFSA.

(6) In the sodium secondary battery using a molten salt electrolyte described in (4) above, the electrolyte includes a cationic species containing a sodium cation and an organic cation and an anionic species containing a sulfonyl amide anion selected from bis(fluorosulfonyl) amide (FSA) and bis(trifluoromethyl sulfonyl) amide (TFSA).

(7) In the sodium secondary battery using a molten salt electrolyte described in any one of (4) to (6) above, a positive electrode active material includes NaCrO₂.

### Advantageous Effects of Invention

The present invention can provide a negative electrode active material and a negative electrode for a sodium secondary battery using a molten salt electrolyte that can improve cycle characteristics. By using the negative electrode active material and the negative electrode, it is possible to provide a sodium secondary battery using a molten salt electrolyte having good cycle characteristics and a high capacity density.

### BRIEF DESCRIPTION OF DRAWING

FIG. 1 is a graph showing a charge-discharge curve of a sodium secondary battery using a molten salt electrolyte prepared in Example.

### DESCRIPTION OF EMBODIMENTS

A negative electrode active material according to the present invention is a negative electrode active material for a sodium secondary battery using a molten salt electrolyte, the negative electrode active material including tricobalt tetroxide. According to studies conducted by the inventors of the present invention, it was found that in the case where tricobalt tetroxide is used as a negative electrode active material for a sodium secondary battery using a molten salt electrolyte, during charge, a conversion reaction proceeds in which reduction of tricobalt tetroxide and production of sodium oxide occur.

That is, the use of tricobalt tetroxide as a negative electrode active material can achieve advantages that sodium ions can be satisfactorily stored and released in the negative electrode, the change in the volume of the negative electrode active material between before and after the storing and releasing of sodium ions is decreased, and a stress generated inside the negative electrode active material is suppressed. Consequently, pulverization and detachment of the negative electrode active material can be suppressed, and cycle characteristics of the sodium battery using a molten salt electrolyte can be improved.

The theoretical capacity of tricobalt tetroxide is 890 mAh/g. Thus, a battery having a high capacity can be obtained by using tricobalt tetroxide as a negative electrode active material.

The reaction in the negative electrode can be represented by the following formula.

Co₃O₄+8Na⁺+8e⁻⇄3Co+4Na₂O [Chem. 1]

During discharge, a reaction between metallic cobalt and sodium oxide described in the above formula proceeds, and thus electrons can be extracted. The higher the temperature, the more satisfactorily this reaction proceeds. Since a battery using a molten salt electrolyte operates at a temperature at which an electrolyte melts, the operating temperature is high and thus the above reaction can be satisfactorily allowed to proceed.

The tricobalt tetroxide preferably has an average particle size d₅₀ of 10 μm or less and a maximum particle size dₘₐₓ of 30 μm or less. Tricobalt tetroxide having an average particle size d₅₀ of 10 μm or less and a maximum particle size dₘₐₓ of 30 μm or less is preferable because it is possible to obtain an advantage that a uniform electrode can be formed.

Tricobalt tetroxide more preferably has an average particle size d₅₀ of 5 μm or less and a maximum particle size dₘₐₓ of 10 μm or less.

A negative electrode for a sodium secondary battery using a molten salt electrolyte according to the present invention contains, as a negative electrode active material, the above-described negative electrode active material of the present invention. With this structure, it is possible to provide a negative electrode for a sodium secondary battery using a molten salt electrolyte having good cycle characteristics.

A sodium secondary battery using a molten salt electrolyte according to the present invention is a sodium secondary battery which uses, as an electrolyte, a molten salt electrolyte containing a sodium ion and which includes a positive electrode, a negative electrode, and a separator disposed between the positive electrode and the negative electrode, in which the negative electrode is the negative electrode of the present invention. With this structure, it is possible to provide a sodium secondary battery using a molten salt electrolyte having good cycle characteristics.

A structural example of a sodium secondary battery using a molten salt electrolyte will be specifically described below.

### (Negative Electrode)

A negative electrode includes a negative electrode current collector and a negative electrode active material provided on the negative electrode current collector.

As the negative electrode active material, the negative electrode active material of the present invention is used.

As the negative electrode current collector, for example, aluminum (Al), nickel (Ni), copper (Cu), stainless, or the like can be used. Among these, aluminum is preferable.

The shape of the negative electrode current collector is not particularly limited. The negative electrode current collector may have a plate shape (foil shape) or may be a porous body having a three-dimensional network structure.

An example of means for providing a negative electrode active material on a negative electrode current collector includes mixing a powder of the negative electrode active material with a conductive aid and a binder to prepare a paste, applying the paste onto a negative electrode current collector, adjusting the thickness of the paste, and then conducting drying.

As the conductive aid, for example, carbon black such as acetylene black (AB) or ketjen black (KB), or the like can be preferably used. The content of the conductive aid used in the negative electrode is preferably 40% by mass or less, and in particular, more preferably in the range of 5% to 20% by mass. When the content of the conductive aid is within the above range, a battery having good charge-discharge cycle characteristics and a high-energy density can be easily obtained. The conductive aid may be added in accordance with the conductivity of the positive electrode as required, and the addition of the conductive aid is not essential.

As the binder, for example, polyvinylidene fluoride (PVdF), polytetrafluoroethylene (PTFE), polyimide (PI), or the like can be preferably used. The content of the binder used in the negative electrode is preferably 40% by mass or less, and in particular, more preferably in the range of 1% to 10% by mass. When the content of the binder is within the above range, the negative electrode active material and the conductive aid can be more strongly bonded to each other, and the conductivity of the negative electrode can be easily made appropriate.

### (Positive Electrode)

A positive electrode includes a positive electrode current collector and a positive electrode active material provided on the positive electrode current collector.

The positive electrode active material is preferably a material that can reversibly store and release sodium ions. For example, sodium chromite (NaCrO₂), NaFeO₂, NaFe_{0.5}Mn_{0.5}O₂, etc. can be preferably used. In particular, sodium chromite (NaCrO₂) is good, as a positive electrode active material, in terms of discharge characteristics (such as discharge capacity and flatness of the voltage) and cycle lifetime characteristics.

Aluminum is preferably used as the positive electrode current collector. The shape of the positive electrode current collector is not particularly limited. The positive electrode current collector may have a plate shape (foil shape) or may be a porous body having a three-dimensional network structure.

An example of means for providing a positive electrode active material on a positive electrode current collector includes mixing a powder of the positive electrode active material with a conductive aid and a binder to prepare a paste, applying the paste onto a positive electrode current collector, adjusting the thickness of the paste, and then conducting drying.

As in the case of the negative electrode, for example, carbon black such as acetylene black (AB) or ketjen black (KB), or the like can be preferably used as the conductive aid. As in the negative electrode, the content of the conductive aid used in the positive electrode is preferably 40% by mass or less, and in particular, more preferably in the range of 5% to 20% by mass. When the content of the conductive aid is within the above range, a battery having good charge-discharge cycle characteristics and a high-energy density can be easily obtained. The conductive aid may be added in accordance with the conductivity of the negative electrode as required, and the addition of the conductive aid is not essential.

As in the case of the negative electrode, as the binder, for example, polyvinylidene fluoride (PVdF), polytetrafluoroethylene (PTFE), or the like can be preferably used. As in the case of the negative electrode, the content of the binder used in the positive electrode is preferably 40% by mass or less, and in particular, more preferably in the range of 1% to 10% by mass. When the content of the binder is within the above range, the positive electrode active material and the conductive aid can be more strongly bonded to each other, and the conductivity of the positive electrode can be easily made appropriate.

### (Electrolyte)

Various salts that melt at an operating temperature can be used as molten salts of electrolytes. As a cation of a molten salt, besides sodium (Na), at least one selected from alkali metals such as lithium (Li), potassium (K), rubidium (Rb), and cesium (Cs); and alkaline earth metals such as beryllium (Be), magnesium (Mg), calcium (Ca), strontium (Sr), and barium (Ba) can be used.

In order to lower the melting point of the molten salt, two or more salts are preferably mixed. For example, by using potassium bis(fluorosulfonyl) amide (K—N(SO₂F)₂; KFSA) and sodium bis(fluorosulfonyl) amide (Na—N(SO₂F)₂; NaFSA) in combination, the operating temperature of the resulting battery can be made 90° C. or lower.

The mixing ratio of KFSA and NaFSA is preferably in the range of 40:60 to 60:40. Thus, the operating temperature of the battery can be lowered. In the case where the molten salt electrolyte includes a sodium cation and an organic cation, the operating temperature of the sodium secondary battery can be further lowered.

As a specific organic cation, at least one selected from a quaternary ammonium ion, an imidazolium ion, an imidazolinium ion, a pyridinium ion, a pyrrolidinium ion, a piperidinium ion, a morpholinium ion, a phosphonium ion, a piperazinium ion, and a sulfonium ion. In this case, a sulfonyl amide anion selected from bis(fluorosulfonyl) amide (FSA) and bis(trifluoromethyl sulfonyl) amide (TFSA) is used as an anionic species of the molten salt electrolyte.

### (Separator)

A separator is a component that prevents the positive electrode from contacting the negative electrode. A glass nonwoven fabric, a porous resin porous body, or the like can be used as the separator. The molten salt is impregnated into the separator.

### (Battery)

The negative electrode, the positive electrode, and the separator impregnated with the molten salt are stacked and housed in a case, and can be used as a battery.

### EXAMPLES

The present invention will now be described in more detail on the basis of Examples. However, the present invention is not limited to the Examples.

### Example 1

### (Preparation of Negative Electrode)

An aluminum (Al) foil having a thickness of 20 μm and a diameter ϕ of 1.5 cm was used as a negative electrode current collector. Tricobalt tetroxide (Co₃O₄) having an average particle size d₅₀ of 10 μm and a maximum particle size dₘₐₓ of 30 μm was used as a negative electrode active material. Acetylene black was used as a conductive aid, and polyvinylidene fluoride was used as a binder.

These components were mixed such that the content of Co₃O₄ was 85% by mass, the content of acetylene black was 5% by mass, and the content of polyvinylidene fluoride was 10% by mass. N-Methyl-2-pyrrolidone (NMP) was added dropwise to and mixed with this mixture to prepare a paste. The paste was applied onto the Al foil and pressure-bonded to adjust the thickness of the paste to 50 μm. Subsequently, the paste was dried at 150° C. for 10 minutes to obtain a negative electrode 1.

### (Preparation of Positive Electrode)

An aluminum (Al) foil having a thickness of 20 μm and a diameter ϕ of 1.5 cm was used as a positive electrode current collector.

Sodium chromate (NaCrO₂) having an average particle size d₅₀ of 10 μm and a maximum particle size dₘₐₓ of 30 μm was used as a positive electrode active material. Acetylene black was used as a conductive aid, and polyvinylidene fluoride was used as a binder.

These components were mixed such that the content of NaCrO₂ was 85% by mass, the content of acetylene black was 5% by mass, and the content of polyvinylidene fluoride was 10% by mass. N-Methyl-2-pyrrolidone (NMP) was added dropwise to and mixed with this mixture to prepare a paste. The paste was applied onto the Al foil and pressure-bonded to adjust the thickness of the paste to 50 μm. Subsequently, the paste was dried at 150° C. for 10 minutes to obtain a positive electrode 1.

### (Electrolyte)

An NaFSA-KFSA molten salt containing sodium ions (NaFSA: 56 mol %, KFSA: 44 mol %) was used as an electrolyte. This molten salt had a melting point of 57° C.

This molten salt was impregnated into a glass separator (porous glass cloth) functioning as a separator, the glass separator having a thickness of 200 μm.

### (Preparation of Sodium Secondary Battery Using Molten Salt Electrolyte)

The separator impregnated with the molten salt was disposed between the negative electrode and the positive electrode prepared above. The negative electrode, separator, and positive electrode thus stacked were housed in a coin-shaped battery case. Thus, a sodium secondary battery 1 using a molten salt electrolyte was obtained.

### Example 2

A sodium secondary battery 2, which was alternative to the sodium secondary battery 1, was obtained as in Example 1 except that the molten salt electrolyte composition used in Example 1 was changed from the NaFSA-KFSA molten salt (NaFSA: 56 mol %, KFSA: 44 mol %) to a molten salt electrolyte including a sodium cation and an organic cation.

In this case, N-methyl-N-propyl pyrrolidinium bis(fluorosulfonyl) amide (hereinafter referred to as “P13FSA”) was selected as a molten salt electrolyte using an organic cation. This P13FSA was mixed with sodium bis(fluorosulfonyl) amide (hereinafter referred to as “NaFSA”) such that a ratio P13FSA/NaFSA (molar ratio) was 9/1. The mixed molten salt electrolyte prepared as described above was used.

### Comparative Example

A sodium secondary battery 3 using a molten salt electrolyte was obtained as in Example except that a negative electrode composed of metallic Sn was used as the negative electrode. A metallic Sn having a thickness of 2 μm and a diameter 4) of 1.5 cm was used.

### —Evaluation of Battery—

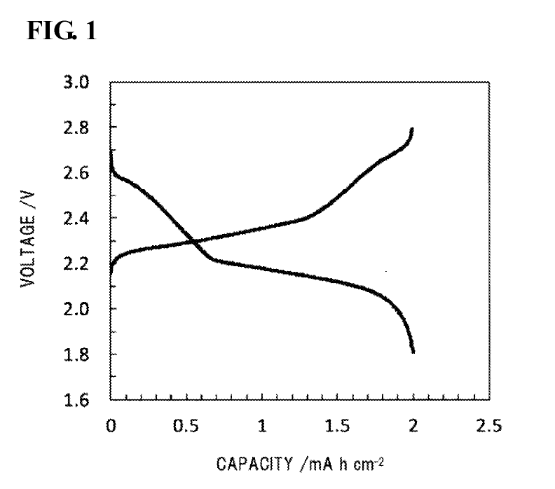

A charge-discharge test of the above-prepared sodium secondary battery 1 using the molten salt electrolyte was conducted under the conditions of an operating temperature of 80° C., a charging start voltage of 1.8 V, a discharging start voltage of 2.8 V, and a current density of 0.2 mA/cm². The results are shown in FIG. 1. The capacity density of the negative electrode was 2 mAh/cm².

As is apparent from FIG. 1, the negative electrode prepared by using the tricobalt tetroxide (Co₃O₄) active material of the present invention has a good performance of a high capacity density as a negative electrode for a sodium secondary battery using a molten salt electrolyte.

Furthermore, charge-discharge cycle characteristics were examined as a durability evaluation. The cycle characteristics are an important indicator that represents the lifetime of the cell. The cycle characteristics were evaluated under the following conditions. A charge-discharge cycle was repeated 100 times at an ambient temperature of 90° C., at a voltage between 1.8 V to 2.8 V, and at a constant current of 0.2 mA/cm². The discharge capacity after 100 cycles was measured and compared with the initial capacity. The results are shown in Table I. In Table I, the battery described as “Example” is the sodium secondary battery 1, and the battery described as “Comparative Example” is the sodium secondary battery 3. Note that, although not shown in Table I, the sodium secondary battery 2 showed substantially the same performance as that of the sodium secondary battery 1.

These results show that a sodium secondary battery that uses a molten salt electrolyte and that includes a negative electrode prepared by using the tricobalt tetroxide (Co₃O₄) active material of the present invention provides a sodium secondary battery having good cycle characteristics.

TABLE I

| | Discharge capacity | | |
|---|---|---|---|
| | (mAh/cm²) | | Capacity |
| | | After | maintenance |
| | Initial | 100 cycles | rate (%) |
| Example | 2 | 1.85 | 92.5 |
| Comparative | 2 | 1.2 | 60 |
| example | | | |

The above results show that the sodium battery using a molten salt electrolyte of the present invention has a high capacity density, good cycle characteristics, and an improved lifetime.

The present invention has been described on the basis of embodiments, but the present invention is not limited to the embodiments described above. Various modifications can be added to the above embodiments within a scope that is the same as or equivalent to that of the present invention.

1. A negative electrode active material for a sodium secondary battery using a molten salt electrolyte,
the negative electrode active material comprising tricobalt tetroxide.

2. The negative electrode active material according to claim 1, wherein the tricobalt tetroxide has an average particle size d₅₀ of 10 μm or less and a maximum particle size dₘₐₓ of 30 μm or less.

3. A negative electrode for a sodium secondary battery using a molten salt electrolyte, the negative electrode comprising, as a negative electrode active material, the negative electrode active material according to claim 1.

4. A sodium secondary battery using, as an electrolyte, a molten salt electrolyte containing a sodium ion, the sodium secondary battery comprising a positive electrode, a negative electrode, and a separator disposed between the positive electrode and the negative electrode, wherein the negative electrode is the negative electrode according to claim 3.

5. The sodium secondary battery using a molten salt electrolyte according to claim 4, wherein the electrolyte contains NaFSA and KFSA.

6. The sodium secondary battery using a molten salt electrolyte according to claim 4, wherein the electrolyte includes a cationic species containing a sodium cation and an organic cation and an anionic species containing a sulfonyl amide anion selected from bis(fluorosulfonyl) amide (FSA) and bis(trifluoromethyl sulfonyl) amide (TFSA).

7. The sodium secondary battery using a molten salt electrolyte according to claim 4, wherein a positive electrode active material includes NaCrO₂.

8. The sodium secondary battery using a molten salt electrolyte according to claim 5, wherein a positive electrode active material includes NaCrO₂.

9. The sodium secondary battery using a molten salt electrolyte according to claim 6, wherein a positive electrode active material includes NaCrO₂.
